(19) United States
(12) Patent Application Publication
(10) Pub. No.: US 2021/0406864 A1
(43) Pub. Date: Dec. 30, 2021

(54) CONTACTLESS PAYMENT SYSTEM

(71) Applicant: Purewrist LLC, New York, NY (US)

(72) Inventors: Ari Gardiner, New York, NY (US); Suresh Palliparambil, San Ramon, CA (US); Eric Gardiner, New York, NY (US); Keith Goldstein, Framingham, MA (US); Glenn Bayer, Westport, CT (US)

(21) Appl. No.: 17/363,245

(22) Filed: Jun. 30, 2021

Related U.S. Application Data
(60) Provisional application No. 63/045,894, filed on Jun. 30, 2020.

(51) Int. Cl. G06Q 20/32; G06Q 20/06; G06Q 30/02

(52) U.S. Cl. CPC G06Q 20/321; G06Q 30/0279; G06Q 20/0655; G06Q 20/3278

(57) ABSTRACT

A system for processing a contactless payment with a vendor using a consumer wearable device includes one or more financial services providers and one or more charitable entities, each financial services provider and each charitable entity comprising a compute device in electronic communication with a central controller managed by a contactless payment facilitator. The central controller maintains and applies a set of transaction parameters to each payment initiated using the consumer wearable device, the transaction parameters including, for example, purchase alerts and restrictions, financial account information, and consumer-defined charitable contributions. By electronically interfacing with the central controller, the consumer can modify the transaction parameters for future payments. Preferably, the consumer wearable device includes a battery-free transponder device with a significantly small form factor which allows for its seamless integration into a wide variety of different wearable articles and relative ease of use.

### CROSS-REFERENCE TO RELATED APPLICATIONS

The present application claims the benefit under 35 U.S.C. 119(e) to U.S. Provisional Patent Application No. 63/045,894, which was filed on Jun. 30, 2020, in the names of Ari Gardiner et al., the disclosure of which is incorporated herein by reference.

### FIELD OF THE INVENTION

The present invention relates generally to contactless payment systems and, more particularly, to contactless payment systems that utilize wearable technology to facilitate financial transactions.

### BACKGROUND OF THE INVENTION

Wearable technology has gained considerable prominence as a transaction vehicle for rendering contactless payments. Traditional wearable technology used in the rendering of contactless payments typically comprises an electronic device, or transponder, which is formed by applying a microchip and an antenna onto a common substrate. The electronic device is commonly retained within a unitary protective housing and, in turn, incorporated into a wearable device, such as a ring, bracelet or watch.

The microchip for the wearable device is provided with a unique identification code which is associated with an account maintained by a server at a financial services center or affiliate. Commonly, the account is either prepaid with a specified amount of money or is linked with a credit account issued by the financial institution (e.g., a credit card company).

To engage in a financial transaction, the wearable device is drawn in close proximity to a contactless payment reader provided by the vendor at the point-of-sale. The reader communicates with the wearable device via wireless communication technology (e.g., radio frequency identification (RFID) or near-field communication (NFC) technology) to initiate the financial transaction. By retrieving the unique identification code from the microchip on the wearable device, the vendor is able to link the purchase with the proper financial account for the consumer at the appropriate financial institution. In this manner, the financial institution, or affiliate thereof, renders payment on behalf of the consumer to the vendor, thereby completing the financial transaction. The consumer account maintained by the financial institution is then adjusted to reflect the transaction payment.

Traditional contactless payment systems and wearable technology used in conjunction therewith have been found to suffer from several notable shortcomings.

As a first shortcoming, traditional contactless payment systems offer limited transactional functionality. For instance, wearable technology associated with a prepaid financial account is often heavily restricted by the active balance for the account, thereby limiting certain transactional opportunities.

As a second shortcoming, the transponder used in most wearable technology is relatively large in size. As a result, integration of the transponder is only possible for certain types of wearable articles, often at the expense of the overall size and/or appearance of such articles.

As a third shortcoming, wearable payment devices are typically manufactured as active devices, which require a battery. As a result, traditional wearable devices not only require periodic charging but also are sensitive to moisture, as such devices cannot typically be washed or otherwise exposed to water.

### SUMMARY OF THE INVENTION

In view thereof, it is an object of the present invention to provide a novel system for processing contactless payments using a consumer wearable device.

It is another object of the present invention to provide a system as described above which allows for greater transactional functionality and control by the consumer.

It is still another object of the present invention to provide a system as described above which supports the processing of contactless payments using consumer wearable devices with a transponder integrated therein that is waterproof, battery-free, and relatively small in size.

It is yet another object of the present invention to provide a system as described above which is inexpensive to implement, is readily scalable, and is easy to use.

Accordingly, as one feature of the present invention, there is provided a system for processing a contactless payment with a vendor using a consumer wearable device, the system comprising (a) at least one financial services provider, each of the at least one financial services provider comprising a compute device for authorizing financial transactions, and (b) a contactless payment facilitator comprising a central controller, the central controller being in electronic communication with the compute device for each of the at least one financial services provider, (c) wherein the central controller maintains a set of transaction parameters for the consumer wearable device, the central controller applying the set of transaction parameters to the contactless payment initiated using the consumer wearable device.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified schematic representation of a contactless payment system constructed according to the teachings of the present invention;

FIGS. 2(a) and 2(b) are top perspective and exploded top perspective views, respectively, of a novel transponder device constructed according to the teachings of the present invention, the transponder device being shown constructed on an adhesive release layer;

FIGS. 3(a) and 3(b) are top perspective views of the transponder device of FIG. 2(b) shown mounted onto the palm and back of a ski glove, respectively, to yield a smart ski glove;

FIGS. 4(a) and 4(b) are top perspective and exploded top perspective views, respectively, of the transponder device of FIG. 2(b) being mounted onto a carrier that facilitates coupling onto the band of a watch in order to yield a smart watch;

FIGS. 5(a) and 5(b) are top perspective and exploded top perspective views, respectively, of the transponder device of FIG. 2(b) being incorporated into a watch band to yield a smart watch band;

FIG. 6 is a top perspective view of a smart watch created using the watch band of FIG. 5(a);

FIGS. 7(a)-(c) are perspective views of the transponder device of FIG. 2(b) shown mounted onto the front panel, back panel, and interior sweatband of a baseball cap to yield a smart cap;

FIG. 8 is a front perspective view of the transponder device of FIG. 2(b) being affixed with a lateral band;

FIG. 9 is a front perspective view of the modified transponder device of FIG. 8 shown mounted onto the back closure of a baseball cap to yield a smart cap;

FIGS. 10(a) and 10(b) are top perspective and exploded top perspective views, respectively, of the transponder device of FIG. 2(b) being incorporated into a cufflink to yield a smart cufflink;

FIGS. 11(a) and 11(b) are top perspective and exploded top perspective views, respectively, of the transponder device of FIG. 2(b) being incorporated into a golf divot repair tool to yield a smart divot repair tool;

FIGS. 12(a) and 12(b) are top perspective and exploded top perspective views, respectively, of the transponder device of FIG. 2(b) being incorporated into a golf ball marker tool to yield a smart ball marker tool;

FIGS. 13(a) and 13(b) are top perspective and exploded top perspective views, respectively, of the transponder device of FIG. 2(b) being incorporated into a ring to yield a smart ring;

FIGS. 14(a) and 14(b) are top perspective and exploded top perspective views, respectively, of the transponder device of FIG. 2(b) being incorporated into a wristband to yield a smart wristband;

FIGS. 15(a) and 15(b) are bottom perspective and top views, respectively, of a modification to the smart wristband of FIG. 14(b), wherein a transparent window is formed in the band and the transponder device is printed with identifying information to yield a smart wristband that can additionally function as a badge;

FIG. 16 is a simplified schematic representation of the contactless payment system of FIG. 1, which has been modified to illustrate how the system may be used to facilitate a contactless transaction; and

FIGS. 17(a)-(g) are various screenshots of a software application which enables the smartphone in FIG. 1 to control certain aspects of transactions engaged using the wearable device.

### DETAILED DESCRIPTION OF THE INVENTION

### Contactless Payment System 11

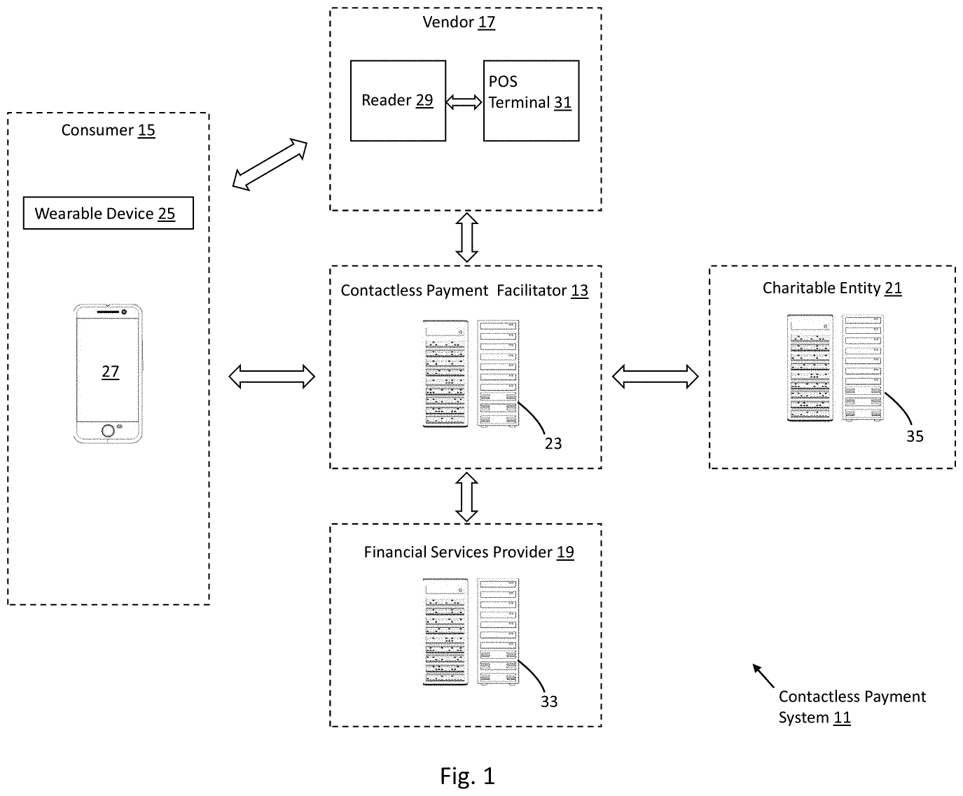

Referring now to FIG. 1, there is shown a contactless payment system constructed according to the teachings of the present invention, the contactless payment system being identified generally by reference numeral 11. As will be explained further below, contactless payment system 11 is uniquely configured to provide the user of a contactless wearable device with enhanced transactional capabilities.

In the description that follows, contactless payment system 11 is described primarily in connection with the execution of financial transactions. However, it is to be understood that contactless payment system 11 is not limited to the execution of financial transactions, but rather, could be utilized in a wide variety of contactless electronic applications (e.g., security applications, loyalty applications, promotional applications, charities, and the like) without departing from the spirit of the present invention.

As seen in FIG. 1, system 11 comprises a contactless payment facilitator 13, which serves as the communication hub between at least one consumer 15, at least one vendor 17, at least one financial services provider 19, and at least one charitable entity 21. As will be described in detail below, the inclusion of contactless payment facilitator 13 into the electronic payment architecture introduces a number of previously unattainable advantages.

Contactless payment facilitator 13 is represented herein as comprising a central controller 23 in the form of a server or other similar web-enabled compute device. Controller 23 is uniquely programmed to execute the novel contactless payment process, which will be described further below.

Consumer 15 represents any individual that seeks to engage in a contactless transaction. Consumer 15 is shown comprising at least one wearable device 25 for executing the contactless transaction as well as a compute device 27 in electronic communication with controller 23. Although compute device 27 is represented in the present embodiment as a smartphone, it is to be understood that compute device 27 represents any web-enabled device that is able to interface with facilitator 13 (e.g., through a designated website or software application). As will be explained further below, wearable device 25 utilizes a novel transponder construction, which in turn affords greater design flexibility and operational capabilities. Additionally, the ability to interact with controller 23 via compute device 27 affords consumer 15 with enhanced transactional controls, alerts, and other related benefits.

Vendor 17 represents any entity that wishes to engage in a contactless financial transaction at a point-of-sale. Vendor 17 is represented herein as comprising a contactless payment reader 29 which is designed to wirelessly communicate with wearable device 25 to initiate a desired financial transaction. Reader 29 is, in turn, electrically connected to a point-of-sale (POS) terminal 31 that is programmed to process financial transactions. As will be explained further below, POS terminal 31 is in electrical communication with central controller 23 and interacts with controller 23 as part of the financial transaction process.

Financial services provider 19 represents any financial institution, or affiliate thereof, which maintains a financial account for consumer 15. For instance, provider 19 may be in the form of a banking institution which maintains a financial account for consumer 15, such as an automated clearing house (ACH) account capable of supporting both direct debit and credit-based transactions. For simplicity purposes, financial services provider 19 is represented as a single entity in the drawings. However, it is to be understood that financial services provider 19 may encompass both a financial/banking institution as well as affiliated electronic payment networks, such as Mastercard or VISA, for transacting financial transactions from such institutions.

Financial services provider 19 is shown comprising a compute device 33 in communication with central controller 23. Among other things, computer device 33 maintains the financial account information for consumer 15 and, if appropriate, verifies the processing of any contactless transactions initiated by consumer 15.

Charitable entity 21 represents any charitable institution prepared to receive financial donations. Charitable entity 21 is shown comprising a compute device 35 in electronic communication with central controller 23. In this capacity, compute device 35 is designed to automatically receive donations from central controller 23 on certain financial transactions based upon specific parameters established by consumer 15 via compute device 27, as will be explained further below.

### Wearable Device 25

As referenced briefly above, wearable device 25 is utilized by consumer 15 to engage in a contactless transaction with vendor 17. Wearable device 25 comprises a transponder device 41 that is incorporated into a wearable article. As will be explained in detail below, various techniques may be employed for incorporating transponder device 41 into a wearable article including, but not limited to, surface mounting, embedding, clasping, and the like.

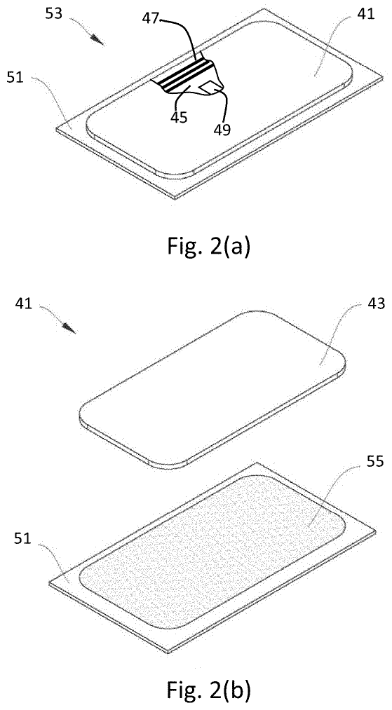

As seen most clearly in FIG. 2(a), transponder device 41 is a unitary, miniature, prefabricated component that includes an outer protective housing 43 into which is disposed a substrate 45 constructed of a suitable non-conductive material, such as plastic. Transponder device 41 additionally includes an antenna 47 and a microchip 49, both of which are mounted on substrate 45 in electrical communication with one another.

Microchip 49 represents any well-known ISO/IEC-compliant microprocessor which can be used in contactless payment transactions. For instance, microchip 49 may be in the form of either a near-field communication (NFC) payment chip with an embedded Secure Element (SE) or a radio frequency identification (RFID) chip. Microchip 49 has the ability to store multiple applets to support various contactless applications.

As a principal feature of the present invention, transponder device 41 is significantly miniaturized in size, particularly in comparison to transponders typically utilized in wearable technology. For instance, in one implementation of the invention, transponder device 41 is constructed with a length of approximately 26 millimeters and a width of approximately 16 millimeters.

Due to its substantially miniaturized form factor, transponder device 41 is particularly well-suited for incorporation into a wide variety of wearable articles through various means of interconnection. In addition, transponder device 41 is preferably constructed as a passive device, which does not require a battery and, as such, any charging requirements. As a result, transponder device 41 can be incorporated into virtually any item and thereby render the item payment ready or otherwise available for various types of contactless transactions. For comprehensiveness and ease of understanding, a non-exhaustive sampling of wearable devices equipped with transponder device 41 is set forth in detail below.

Furthermore, transponder device 41 may be constructed with a fastener, adhesive, clasp or other affixing means in order to readily secure transponder device 41 onto a wearable article. Although not shown herein, it is to be understood that transponder device 41 may also be inserted into a pocket, or sleeve, which has an exposable adhesive layer.

For instance, as shown in FIGS. 2(a) and 2(b), transponder device 41 may be constructed on an adhesive release layer 51 to form a transponder assembly 53. As part of this construction, an adhesive 55 is exposed on the underside of transponder device 41 upon removal from release layer 51. Accordingly, adhesive 55 enables transponder device 41 to be readily secured onto a wide array of wearable articles in order to achieve ubiquitous usage in a variety of different applications.

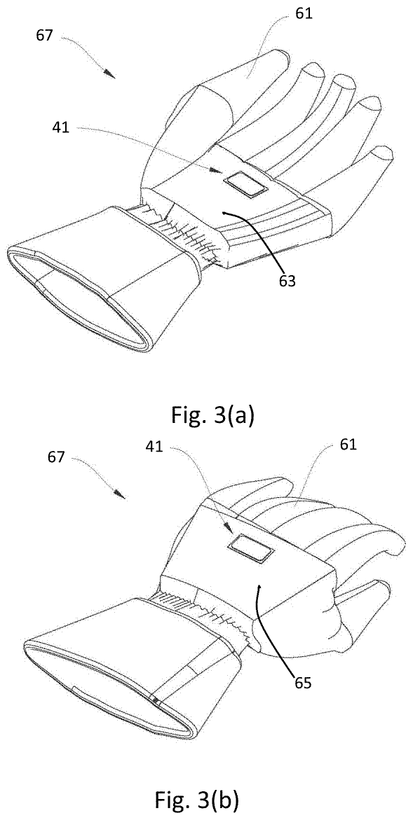

For example, in FIG. 3(a), a ski glove 61 is shown with transponder device 41 adhesively mounted onto its palm, or anterior, region 63. Similarly, in FIG. 3(b), ski glove 61 is shown with transponder device 41 adhesively mounted onto its back, or posterior, region 65. Due to its limited size, it is envisioned that transponder device 41 could be mounted on any non-intrusive region on ski glove 61 without departing from the spirit of the present invention.

By securing transponder device 41 onto glove 61 at any appropriate location, glove 61 effectively becomes a smart glove 67 which is capable of a wide range of contactless transactions. For instance, it is envisioned that transponder device 41 could provide its wearer with, inter alia, the ability to obtain verified access to certain outdoor amenities (e.g., as an electronic ski tag), to purchase items in a contactless manner (e.g., refreshments), or ride a subway in a public transportation system.

Although the present invention discloses a ski glove, it is to be understood that other similar types of gloves could be incorporated with transponder device 41 in a similar fashion to form a smart glove.

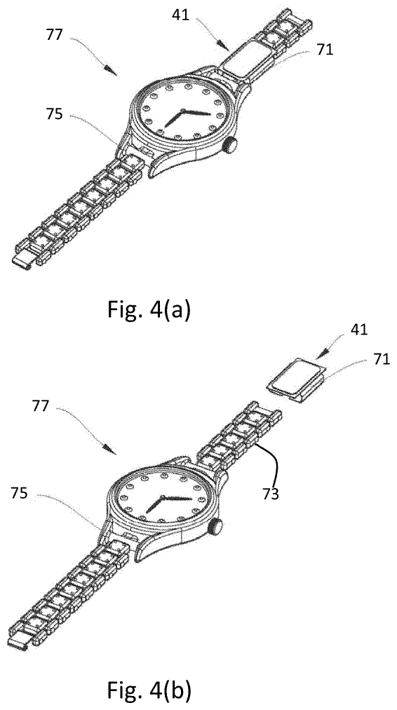

As another example, in FIGS. 4(a) and 4(b), transponder device 41 is shown mounted onto a U-shaped bracket, or carrier, 71. Bracket 71 is provided with a pair of opposing side rails to facilitate mounting on any strap-type device. For illustrative purposes only, bracket 71 is shown mounted onto a link-style band 73 of a conventional watch 75 to create a smart watch 77. Preferably, the side rails are sized and/or capable of slight articulation, or bending, to temporarily lock bracket 71 in place on strap 73, regardless of its size. In this manner, conventional watch 75 is able to be retrofitted with contactless transaction capabilities.

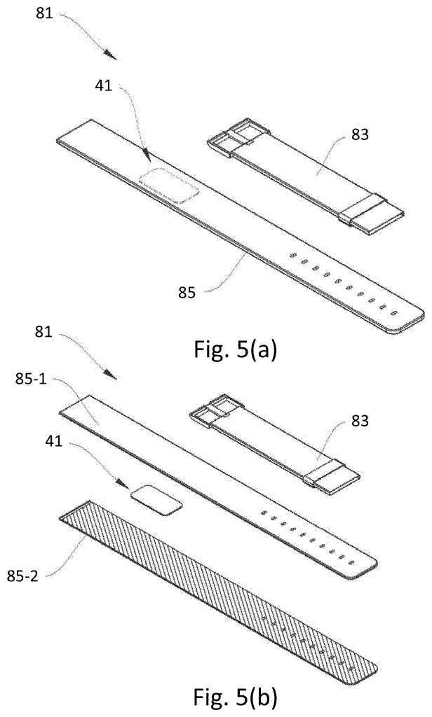

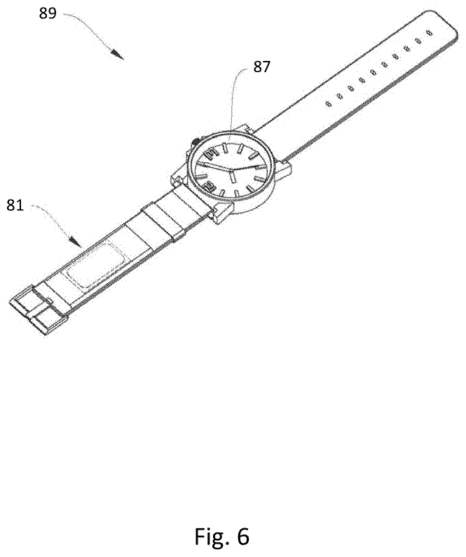

As another example, in FIGS. 5(a) and 5(b), a smart watch band 81 is shown. As can be seen, band 81 comprises a buckle-side strap 83 and a point-side strap 85. In the present example, point-side strap 85 includes identically dimensioned top and bottom layers 85-1 and 85-2 between which transponder device 41 is disposed. Therefore, by securing layers 85-1 and 85-2 together (e.g., through their region of contact or stitched together about their peripheries), transponder device 41 is effectively embedded in point-side strap 85. Accordingly, as shown in FIG. 6, smart watch band 81 can therefore be used to replace the band of a conventional watch 87 to create a smart watch 89 with contactless transaction capabilities.

It should be noted that although transponder device 41 is shown embedded in point-side strap 85 of watch band 81, it is to be understood that transponder device 41 could be similarly embedded in buckle-side strap 83 of watch band 81 without departing from the spirit of the present invention.

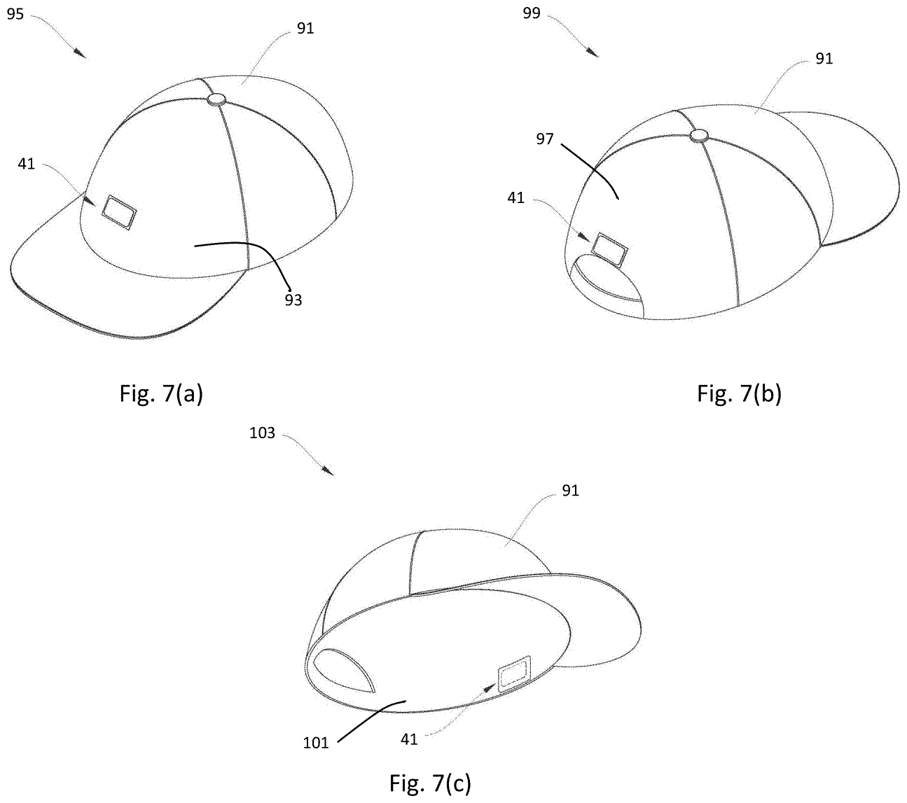

As another example, in FIG. 7(a), a baseball cap 91 is shown with transponder device 41 adhesively mounted onto its front panel 93 to yield a smart cap 95. Similarly, in FIG. 7(b), baseball cap 91 is shown with transponder device 41 adhesively mounted onto its back panel 97 to yield a smart cap 99. Further, in FIG. 7(c), baseball cap 91 is shown with transponder device 41 adhesively mounted onto its interior sweatband 101 to yield a smart cap 103. Due to its limited size, it is envisioned that transponder device 41 could be mounted on any non-intrusive region on baseball cap 91 without departing from the spirit of the present invention.

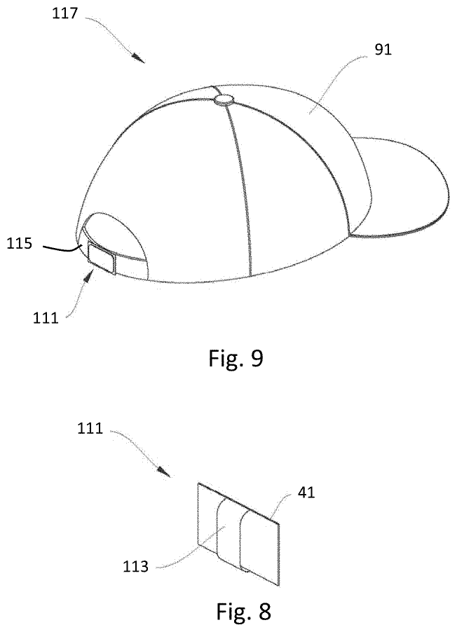

Notably, in FIG. 8, a transponder device assembly 111 is shown which is uniquely constructed for mounting onto the back closure of a baseball cap. Transponder device assembly 111 comprises a lateral band, or loop, 113 which is secured to opposing side edges of transponder device 41. In this manner, back closure 115 of baseball cap 91 can be fed between transponder device 41 and band 113 in order to retain transponder device assembly 111 on baseball cap 91 and thereby yield a smart cap 117.

By securing transponder device 41 onto hat 91 at any appropriate location, hat 91 effectively becomes a smart hat which is capable of a wide range of contactless transactions. For instance, it is envisioned that transponder device 41 could provide its wearer with, inter alia, the ability to obtain verified access to certain amenities (e.g., as an electronic ticket at a professional baseball game) or to purchase items in a contactless manner (e.g., refreshments).

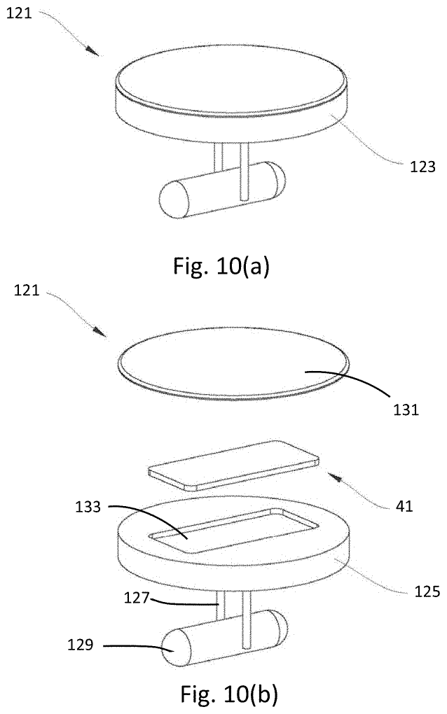

As another example, in FIGS. 10(a) and 10(b), a smart cufflink 121 is shown which includes a cufflink 123 that is uniquely constructed to receive transponder device 41. Specifically, cufflink 123 is similar to a conventional cufflink in that cufflink 123 comprises an enlarged button-shaped back plate 125 from which extends a pair of parallel posts 127. A toggle 129, appropriately dimensioned for insertion through a conventional buttonhole, is pivotally coupled to posts 127. An enlarged, disc-shaped front plate 131 is mounted onto the front surface of back plate 125 to provide cufflink 123 with its ornamental appearance.

Cufflink 123 differs from a conventional cufflink in that back plate 125 is shaped to define a shallow cavity 133 in its exposed top surface. Cavity 133 is appropriately dimensioned to fittingly receive transponder device 41 such that front plate 131 lies flush on back plate 125 with transponder device 41 disposed within cavity 133. Constructed as such, smart cufflink 121 not only functions as a cufflink but is capable of a wide range of contactless transactions. For instance, it is envisioned that smart cufflink 121 could provide its wearer with, inter alia, the ability to obtain verified access to a particular area or purchase items in a contactless manner (e.g., refreshments).

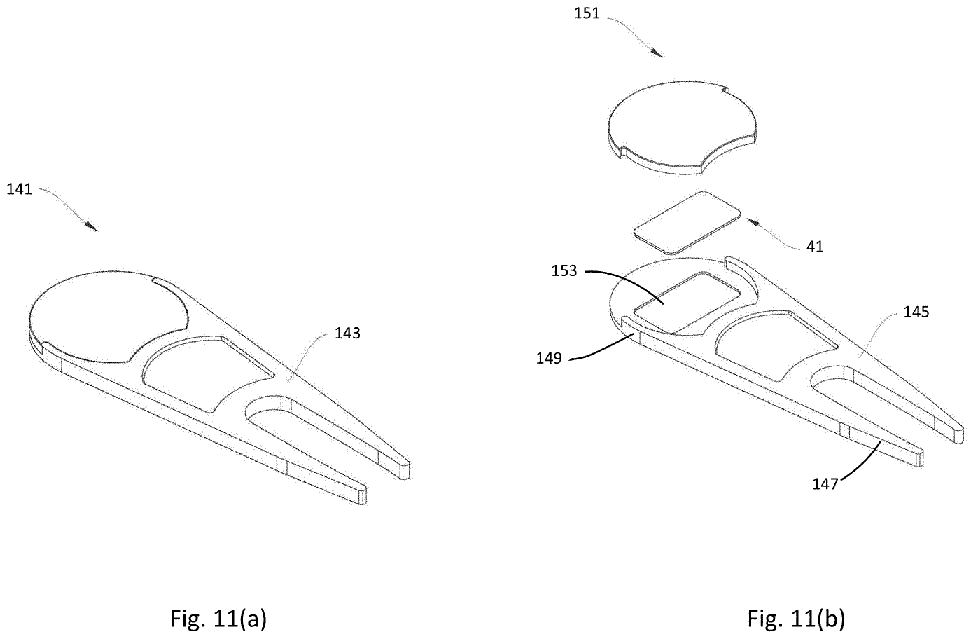

As another example, in FIGS. 11(a) and 11(b), a smart divot repair tool 141 is shown which includes a divot repair tool 143 that is uniquely constructed to receive transponder device 41. Specifically, divot repair tool 143 is similar to a conventional golf divot repair tool in that tool 143 comprises a main handle 145 from which extends a pair of spaced apart prongs 147. An enlarged head 149 is formed at the opposite end of handle 145 and is adapted to receive a ball marker 151.

Tool 141 differs from a conventional divot repair tool in that head 149 is shaped to define a shallow cavity 153 in its exposed top surface. Cavity 153 is appropriately dimensioned to fittingly receive transponder device 41 such that marker 151 lies flush on head 149 with transponder device 41 disposed within cavity 153. Constructed as such, smart tool 141 not only functions as a divot repair tool but is also capable of a wide range of contactless transactions. For instance, it is envisioned that smart tool 141 could provide its wearer with, inter alia, the ability to obtain verified access to a particular area (e.g., a golf course) or purchase items in a contactless manner (e.g., refreshments).

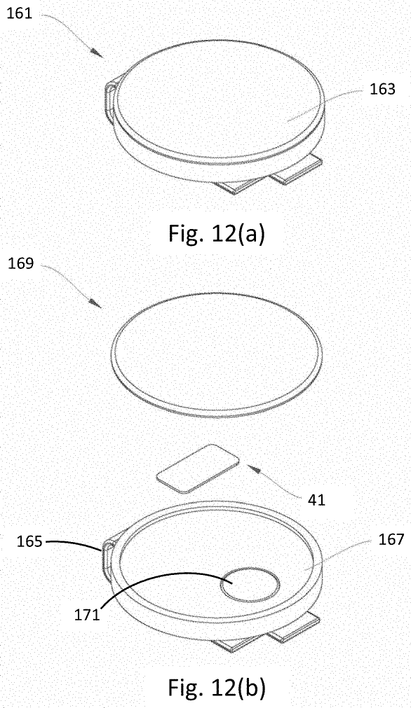

As another example, in FIGS. 12(a) and 12(b), a smart golf ball marker tool 161 is shown which includes a ball marker tool 163 that is uniquely constructed to receive transponder device 41. Specifically, ball marker tool 163 is similar to a conventional golf ball marker tool in that tool 163 comprises a C-shaped clip 165 which is adapted to be releasably secured onto an article of clothing, such as the brim of a cap. An enlarged head 167 is formed on clip 165 and is adapted to removably receive a ball marker 169, such as through the use of a magnet 171.

Tool 163 differs from a conventional golf ball marker tool in that head 167 is adapted to receive transponder device 41 such that marker 169 lies flush on head 167 with transponder device 41 disposed therebetween. Constructed as such, smart tool 161 not only functions as a ball marker but is also capable of a wide range of contactless transactions. For instance, it is envisioned that smart tool 161 could provide its wearer with, inter alia, the ability to obtain verified access to a particular area (e.g., a golf course) or purchase items in a contactless manner (e.g., refreshments).

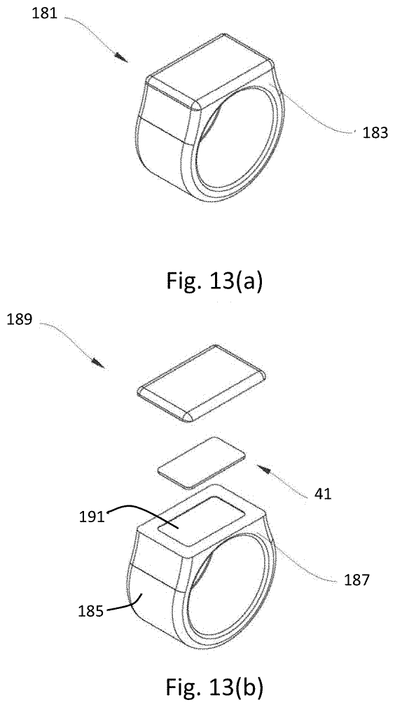

As another example, in FIGS. 13(a) and 13(b), a smart ring 181 is shown which includes a ring 183 that is uniquely constructed to receive transponder device 41. Specifically, smart ring 181 is similar to a conventional ring in that ring 181 comprises a band 185 on which is formed an enlarged head, or crown, 187. An enlarged, decorative, front plate 189 is mounted onto crown 187 to provide ring 181 with its ornamental appearance.

Ring 181 differs from a conventional ring in that crown 187 is shaped to define a shallow cavity 191 in its exposed top surface. Cavity 191 is appropriately dimensioned to fittingly receive transponder device 41 such that front plate 189 lies flush on crown 187 with transponder device 41 disposed within cavity 191. Constructed as such, smart ring 181 not only functions as a ring but is also capable of a wide range of contactless transactions. For instance, it is envisioned that smart ring 181 could provide its wearer with, inter alia, the ability to obtain verified access to a particular area or purchase items in a contactless manner.

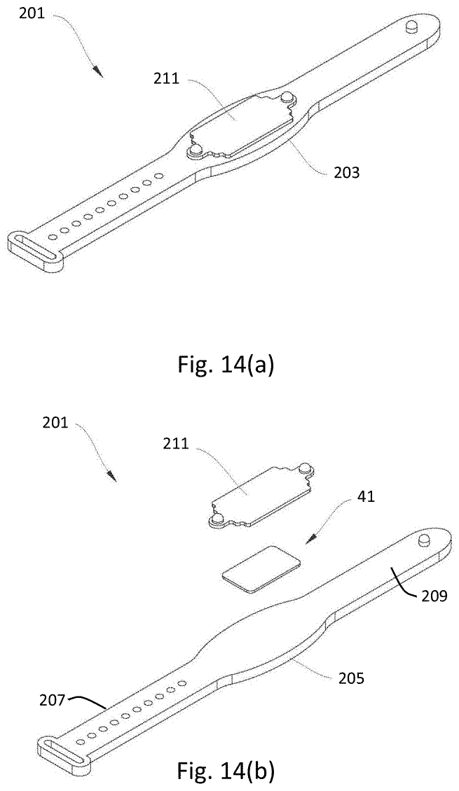

As another example, in FIGS. 14(a) and 14(b), a smart bracelet, or band, 201 is shown which includes a bracelet 203 that is uniquely constructed to receive transponder device 41. Specifically, bracelet 203 is formed as a unitary band of material that is shaped to define an enlarged, flattened face 205 from which projects, in opposing directions, a buckle-side strap 207 and a point-side strap 209.

Band 201 differs from conventional bracelets in that a back plate, or backing, 211 is adapted to be releasably fastened to the underside of face 205 (e.g., through the use of complementary pins and posts). Accordingly, the thin profile of transponder device 41 allows for its positioning between face 205 and backing 211. Constructed as such, smart band 201 is capable of a wide range of contactless transactions.

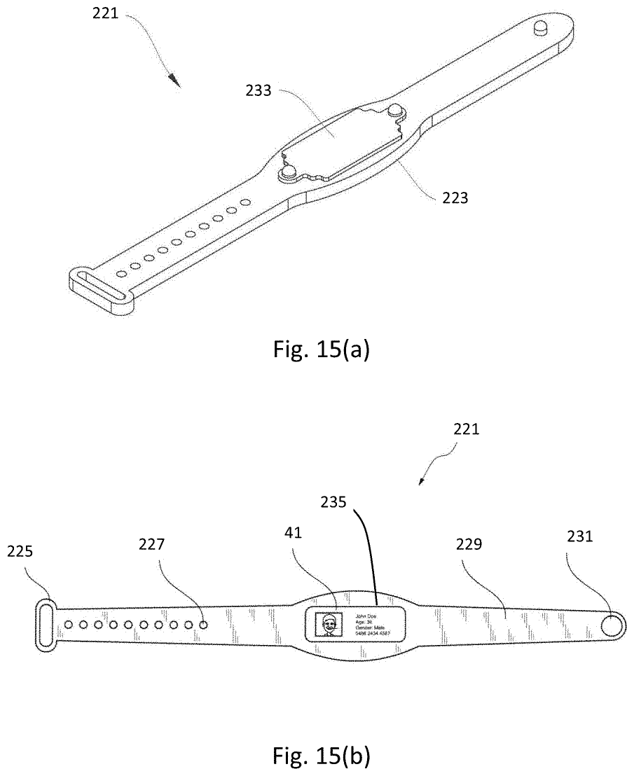

As another example, in FIGS. 15(a) and 15(b), a modification of smart band 201 is shown, the modified smart band being identified generally by reference numeral 221. As can be seen, smart band 221 is similar to smart band 201 in that smart band 221 is formed as a unitary band of material that is shaped to define an enlarged, flattened face 223 from which projects, in opposing directions, a buckle-side strap 225 with a linear array of holes 227 and a point-side strap 229 with a fastening post 231. Additionally, a back plate, or backing, 233 is adapted to be releasably fastened to the underside of face 223.

Band 221 differs from band 201 in that a transparent window 235 is formed in face 223. Accordingly, by printing unique identifying information (e.g., a picture, name, social security number or the like) onto the top surface of transponder device 41, the information becomes visible through window 235 upon assembly of band 221. In this manner, it is envisioned that smart band 221 could not only provide a wide range of contactless transactions, but also, establish an additional level of security by serving as a miniature photo identification card or badge (e.g., where secure access is required).

### Method of Transacting Contactless Payment Using System 11

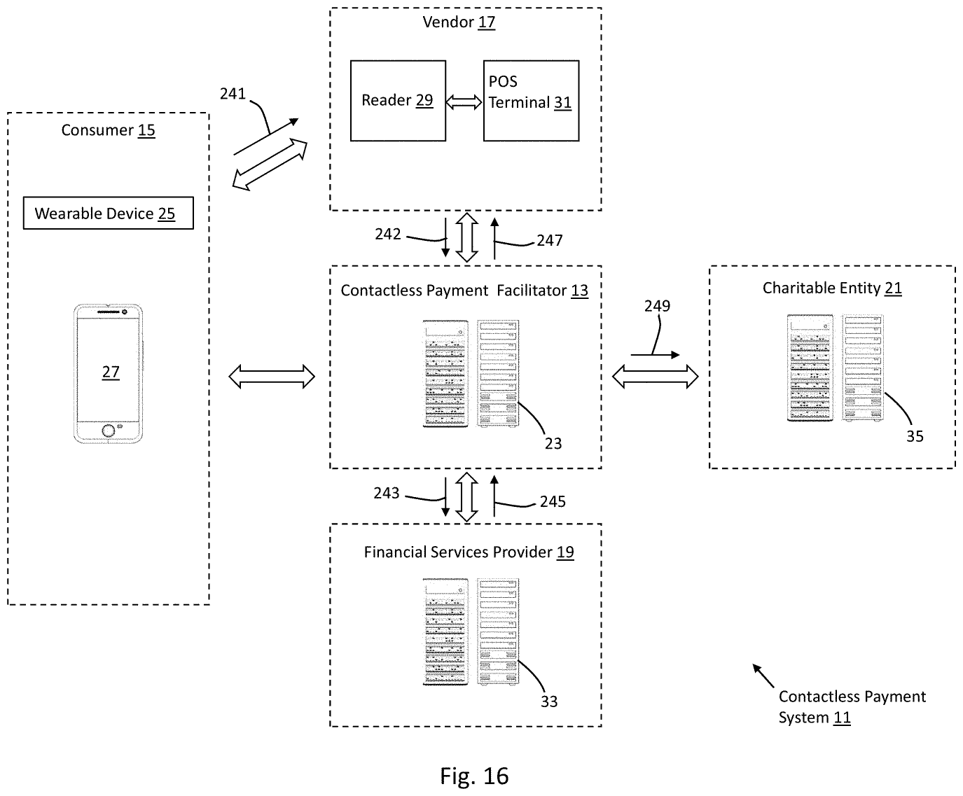

Referring now to FIG. 16, system 11 may be utilized in the following manner to facilitate a contactless transaction. To initiate a contactless transaction, wearable device 25 is drawn in proximity to reader 29. In response to interrogation signals periodically sent by reader 29, normally passive wearable device 25 wirelessly transmits a response signal to reader, as represented by reference numeral 241 in FIG. 16. It should be noted that the response signal includes identifying information which in turn can be utilized to effectuate a financial transaction (e.g., an account number or token).

In response, POS terminal 31 transmits a transaction request to contactless payment facilitator 13 using the identifying information provided by wearable device 25, the request being represented generally be reference numeral 242. In turn, facilitator 13 transmits a corresponding request to financial services provider 19, as represented by reference numeral 243. In this manner, financial services provider 19 authenticates consumer 15 and verifies whether the identified account has the necessary resources to proceed with the financial transaction as part of a response 245.

Facilitator 13 relays the response to POS terminal 31, as represented by reference numeral 247. If acceptable, POS terminal 31 processes the transaction. By contrast, if the transaction is denied, vendor 17 notifies consumer 15 that the transaction cannot be processed.

As a principal feature of the present invention, consumer 15 can directly interface with facilitator 13 using compute device 27. By navigating through a user-friendly, front-end, software application programming interface (API), consumer 15 can establish certain parameters for maintaining greater transactional control.

As an example, through such an API, consumer 15 is able to designate a particular charitable entity 21 that is to receive a donation in connection with selected financial transactions. The amount of the donation is established by consumer 15 and may represent, among other things, a set dollar amount per transaction, a set percentage for each transaction, or the difference between the transaction price and the next highest dollar amount. Based on the parameters established by consumer 15 through the front-end API, facilitator 13 issues monetary donations to charitable entity 21 as part of certain transactions, the donation rendering being represented by reference numeral 249 in FIG. 16.

As another example, through such an API, consumer 15 is able to link any credit and/or debit account with wearable device 25. In this capacity, a controlling party (e.g., a parent) can initially fund wearable device 25 with a user-selected dollar amount and thereby enable the using party (e.g., a child) to engage in contactless transactions, as needed. Upon receiving notification that the funding balance for device 25 has fallen beneath a user-defined threshold (e.g., by means of an automated alert to compute device 27), the controlling party can then deposit additional funds from a designed debit or credit account into the wearable account balance or suspend transaction capabilities for a user-specified period of time.

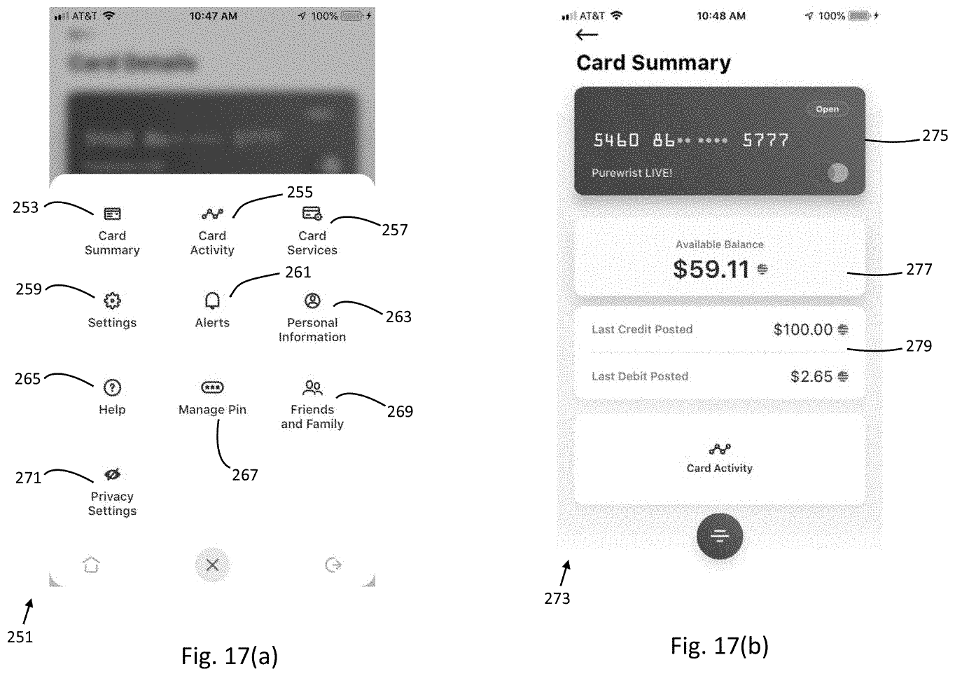

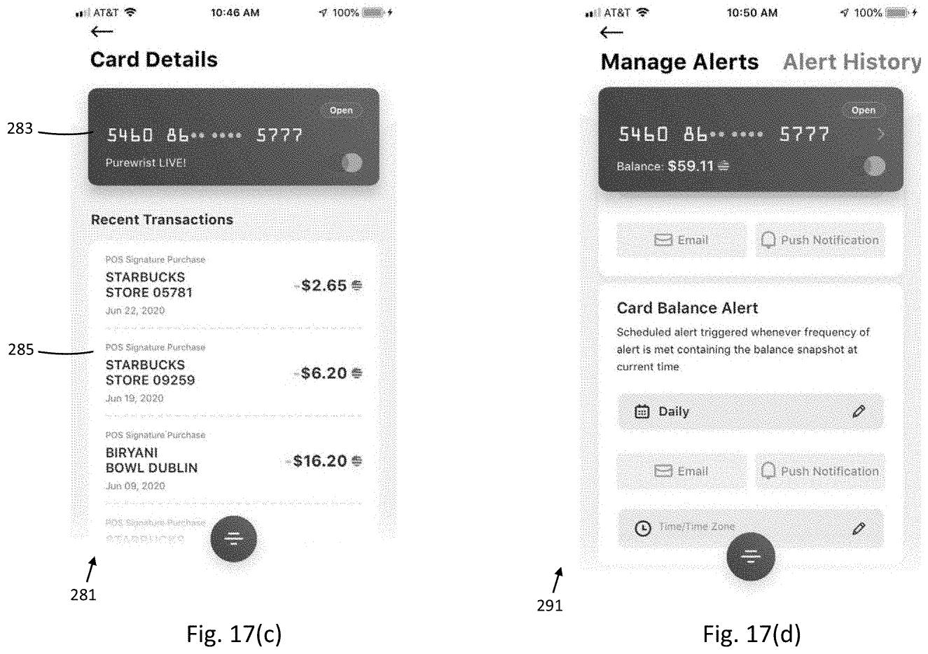

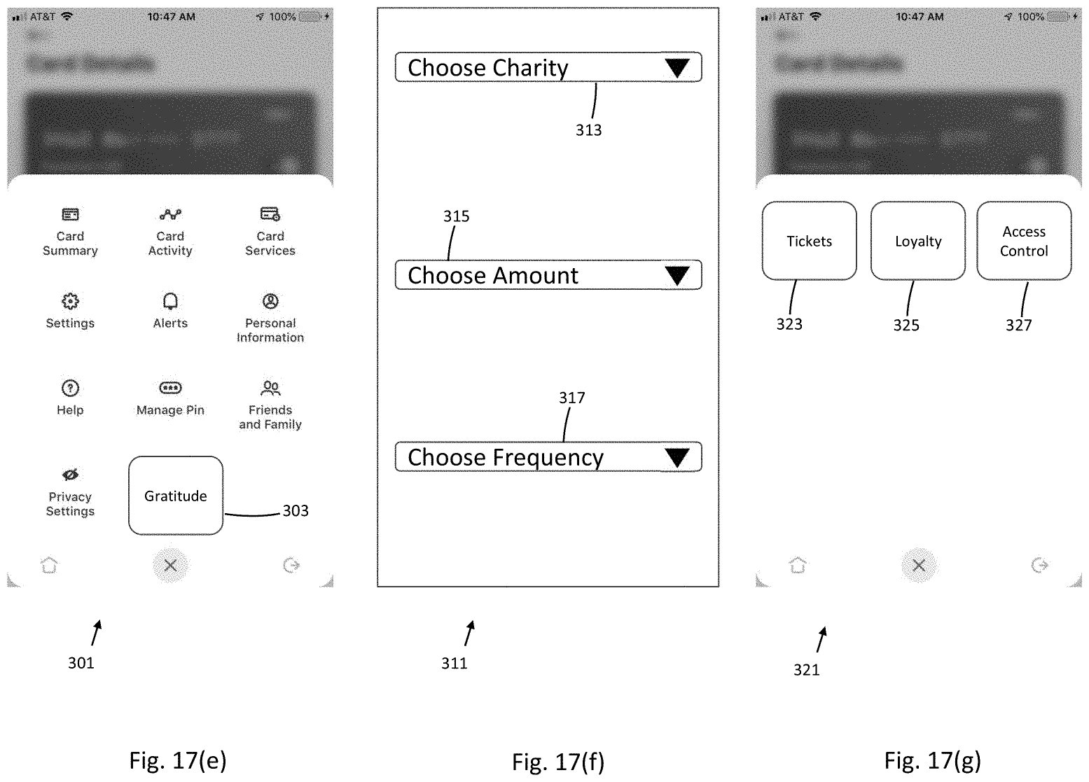

In FIGS. 17(a)-(g), a series of sample screen displays are shown which illustrate various consumer transaction controls which are capable through the front-end API. For instance, in FIG. 17(a), there is shown a sample screen display 251 which depicts a main, or home, screen for initiating certain user transaction controls. As can be seen, display 251 includes, among other things, a card summary button 253, a card activity button 255, a card services button 257, a settings button 259, an alerts button 261, a personal information button 263, a help button 265, a manage pin button 267, a friends and family button 269 for creating access to and for funding particular individuals, and a privacy settings button 271.

In FIG. 17(b), there is shown a sample screen display 273 which generates upon activation of card summary button 253. As can be seen, card summary screen 273 includes, inter alia, a card information window 275 with details relating to the account currently linked with wearable device 25, an available balance window 277, and a recent activity window 279 with details relating to the most recent activity carried out using device 25. Because the available balance is provided via window 277, an individual (e.g., a parent) could elect to reduce the account balance on behalf of the primary user of device 25 (e.g., a child). In this manner, transactional activity for device 25 can be regulated by a supervisory, or managing, entity.

In FIG. 17(c), there is shown a sample screen display 281 which generates upon activation of card activity button 255. As can be seen, card activity screen 281 includes, inter alia, a card information window 283 with details relating to the active financial account linked with wearable device 25, and a recent transaction window 285 with details relating to the last few transactions carried out using device 25. In this manner, a managing entity can actively monitor the specific transactions engaged by the party in possession of wearable device 25.

In FIG. 17(d), there is shown a sample screen display 291 which generates upon activation of alerts button 261. As can be seen, alerts screen 291 enables a managing entity to establish alerts with the linked financial account, wherein the frequency and means of notification (e.g., email, text message, etc.) can be set to the preference of the managing entity.

In FIG. 17(e), there is shown a sample screen display 301 of a modified version of the main, or home, screen for initiating certain user transaction controls. As can be seen, screen display 301 additionally includes a gratitude button 303. Upon activation of button 303, a charity screen display 311 is generated of the type shown in FIG. 17(f). As can be seen, charity screen display 311 includes a charity selection dropdown button 313 for designating a charity to receive automated donations, an amount selection dropdown button 315 for designating the amount of each automated donation, and a frequency selection dropdown button 317 for designating when automated donations are to be rendered.

In FIG. 17(f), an additional sample screen display 321 is provided to illustrate further features which may be attained through the front-end API. Notably, screen display 321 is provided with a tickets button 323 for accessing any electronic tickets, a loyalty button 325 for accessing loyalty/rewards accounts, and an access control button 327 for obtaining authorized access to a secure location.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

### Principal Features and Advantages of the Present Invention

As referenced above, contactless payment system 11 is designed with a number of notable features which provide significant performance advantages over traditional contactless transaction systems.

As a first advantage, the unique architecture of contactless payment system 11, and in particular the inclusion of contactless payment facilitator 13 as its central hub, enables a number of previously unrecognized features to be implemented. In particular, facilitator 13 affords a user with greater control over use of wearable device 25, as the user is capable of, among other things, monitoring recent transaction activity, receiving alerts, limiting or expanding spending limits, establishing charitable donation parameters, and modifying or adding financial accounts to be linked with wearable device 25. Additionally, through the software API, the user can convert a pre-loaded, gift card-type wearable device 25 into a reusable product by linking one or more financial accounts with the device.

As a second advantage, the significantly small form factor of transponder device 41 allows for its seamless integration into a wide variety of different wearable articles, both as custom designed articles as well as conventional articles which can be retrofitted to become smart articles. In this manner, a consumer is capable of concurrently maintaining several different, battery-free, waterproof, wearable devices with a common financial account, thereby promoting contactless transactional capabilities across a wide range of potential applications.

As a third advantage, the unique architecture of contactless payment system 11 as well as the miniaturized form factor of transponder device 41 significantly expands the scope of potential contactless transactions. Notably, system 11 supports ubiquitous use of wearable device 25 not only to engage in financial transactions but also in connection with, among other things, ticketing, loyalty, charity, secure access, event management, and benefits.

What is claimed is:

1. A system for processing a contactless payment with a vendor using a consumer wearable device, the system comprising:
(a) at least one financial services provider, each of the at least one financial services provider comprising a compute device for authorizing financial transactions; and
(b) a contactless payment facilitator comprising a central controller, the central controller being in electronic communication with the compute device for each of the at least one financial services provider;
(c) wherein the central controller maintains a set of transaction parameters for the consumer wearable device, the central controller applying the set of transaction parameters to the contactless payment initiated using the consumer wearable device.

2. The system as claimed in claim 1 wherein the set of transaction parameters applied to the contactless payment initiated using the consumer wearable device is modifiable.

3. The system as claimed in claim 2 further comprising a consumer compute device in electronic communication with the central controller.

4. The system as claimed in claim 3 wherein the set of transaction parameters maintained by the central controller is modifiable by the consumer compute device.

5. The system as claimed in claim 4 wherein the set of transaction parameters maintained by the central controller is modifiable by the consumer compute device through a designated website in communication with the central controller.

6. The system as claimed in claim 4 wherein the set of transaction parameters maintained by the central controller is modifiable by the consumer compute device through a software application programming interface that is designed to communicate with the central controller.

7. The system as claimed in claim 4 wherein the at least one financial services provider comprises a plurality of distinct financial services providers, each of the plurality of distinct financial services providers comprising a compute device in electronic communication with the central controller.

8. The system as claimed in claim 7 wherein one of the set of transaction parameters for the consumer wearable device is the designation of one of the plurality of financial services providers to process the contactless payment using the consumer wearable device.

9. The system as claimed in claim 8 wherein the designation of the one of the plurality of financial services providers to process the contactless payment is modifiable using the consumer compute device.

10. The system as claimed in claim 7 wherein one of the set of transaction parameters for the consumer wearable device is financial restrictions on the contactless payment initiated using the consumer wearable device.

11. The system as claimed in claim 7 wherein the central controller for the contactless payment facilitator issues to the consumer compute device a selection of electronic alerts relating to the contactless payment.

12. The system as claimed in claim 4 further comprising at least one charitable entity, each of the at least one charitable entity comprising a compute device for managing electronic payment of charitable contributions.

13. The system as claimed in claim 12 wherein one of the set of transaction parameters for the consumer wearable device is the designation of one of the at least one charitable entity to selectively receive an electronic payment of a charitable contribution in connection with contactless payments initiated using the consumer wearable device.

14. The system as claimed in claim 13 wherein one of the set of transaction parameters for the consumer wearable device is an electronic payment of a charitable contribution of a set dollar amount to be received by the one of the at least one charitable entity in connection with the contactless payment initiated using the consumer wearable device.

15. The system as claimed in claim 14 wherein the set dollar amount of the charitable contribution is modifiable using the consumer compute device.

16. The system as claimed in claim 13 wherein one of the set of transaction parameters for the consumer wearable device is an electronic payment of a charitable contribution of a set percentage of the contactless payment to be received by the one of the at least one charitable entity.

17. The system as claimed in claim 13 wherein the one of the set of transaction parameters for the consumer wearable device is the frequency of the electronic payment of a charitable contribution received by the at least one charitable entity in relation to the contactless payment.
